(19) United States
(12) Patent Application Publication
(10) Pub. No.: US 2012/0188750 A1
(43) Pub. Date: Jul. 26, 2012

(54) Illuminated Shoe

(76) Inventor: Jez Milton-John Marston, Arlington, VA (US)

(21) Appl. No.: 13/356,608

(22) Filed: Jan. 23, 2012

Related U.S. Application Data
(60) Provisional application No. 61/457,175, filed on Jan. 21, 2011.

(51) Int. Cl. F21V 21/08

(52) U.S. Cl. 362/103

(57) ABSTRACT

An illuminated shoe is provided wherein the entire upper surface of the upper portion of the shoe above the mid sole is illuminated in one continuous uniform glow at the push or switch of an on/off button. Light emitting means of LED bulbs or light strips are placed underneath a frosted or slightly transparent material which is a portion of the surface of the upper. The light emitting means are powered by a built-in and replaceable battery and controlled by a switch or an on/off button.

### REFERENCE TO RELATED APPLICATIONS

This patent application claims the benefit of U.S. Provisional Application No. 61/457,175 filed on Jan. 21, 2011, the disclosure of which is incorporated herein by reference in its entirety.

### BACKGROUND OF THE INVENTION

1. Field of the Invention

The present invention relates to footwear containing illuminating elements. More particularly, the present invention relates to shoes having the entire upper surface of the upper portion of the shoe above the mid sole illuminated in one continuous uniform glow at the push of or switch of an on/off button.

Night safety for outdoor exercisers, e.g. joggers, pedestrians and cyclists, is an ongoing concern. Most people exercise outdoors either early in the morning before going to work or in the evening or at night after returning from work. In crowded urban environments, outdoor exercisers must frequently share the roads with motorists. Dawn and dusk are periods in which a motorist's visibility is notoriously poor. Accordingly, exercisers must take extra precautions to ensure that they are visible to motorists.

In recent years, many exercisers have begun wearing bright or fluorescent colored clothing and /or passive reflectors. However, because these are purely reflective elements, it is necessary for them to be illuminated by an external light source, such as the beam of a motorist's headlight, in order for them to function.

In recent years, athletic shoe manufacturers have developed a variety of shoes having illuminated regions. Some athletic shoes include illuminated portions on the shoe upper. Other athletic shoes contain illuminated portions in the heel. While still other athletic shoes contain illuminated regions in the instep portion of the sole. Typically, the light sources for these shoes are activated each time the wearer's foot makes contact with a surface in a way of blink, strobe or flash so that they remain active for a very limited duration. Thus the wearer has extremely limited control over the duration of illumination. Furthermore, these shoes only have a small portion of the shoe which showcases any lighting or illumination leaving the remaining majority of the shoe as a regular non-illuminated shoe. Also, typically, their shoes use light sources in which the lens of light source point outwards perpendicular to the shoe. This has a tendency to show exactly how many individual bulbs or LEDs are being used to illuminate that small portion of the shoe as opposed to showing a continuous uniform glow. Furthermore, some of these shoes have the illuminating bulbs protruding from the shoe material which leave it exposed and vulnerable to destruction from normal use of the shoe.

What is desired, therefore, are shoes having large regions of the shoe continuously illuminated and providing complete control of the duration of the illumination regardless of whether the wearer is standing still or walking.

2. Description of Related Art

Some related prior inventions are disclosed as prior art herein. More specifically, by way of example,

U.S. Pat. No. 6,837,590 to Marston discloses an illuminated cap and shoe set. A combination cap and shoe set is provided wherein each of the cap and shoe include illuminated regions. The sole of the shoe may also be substantially uniformly illuminated and the illumination may be controlled independent of any walking motion by the wearer by a manual push-button switch.

U.S. Pat. No. 5,930,921 to Sorofman and Armey discloses a shoe wherein the side of its upper or along its outsole has a transparent diffusing element with a convex front face and a multitude of facets in its back face. A pocket opens out of the back face and contains a light emitting diode which is connected to an energizing module in the outsole of the shoe. The circuit contains a switch which is sensitive to impacts, and a battery, and when the switch is subjected to an impact of sufficient magnitude, the circuit impresses across the diode an electrical potential that is derived from the battery.

U.S. Pat. No. 5,813,148 to Guerra discloses Footwear with optical fiber illuminating display areas provides emphasis on illuminating certain features of the footwear, such as trademarks, logos, team sports, cartoon characters, and other artistic designs primarily for advertising, decoration and enhancing the visibility of the wearer.

Unlike the invention described herein none of these prior inventions illuminate the entire shoe.

### SUMMARY OF THE INVENTION

In an exemplary embodiment of the present invention, there is disclosed a shoe having the entire upper surface of the upper portion of the shoe above the mid sole illuminated in one continuous uniform glow at the push of or switch of an on/off button. There are light emitting means placed underneath a frosted or slightly transparent material which is a portion of the surface of the upper. The light emitting means are connected to a switch control device that turns on or off the light emitting means. The light emitting means are also connected to a power module which supplies electricity to the light emitting means.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of a shoe in accordance with one embodiment of the present invention

FIG. 2 is a rear view of a shoe in accordance with one embodiment of the present invention

### DESCRIPTION OF THE PREFERRED EMBODIMENT

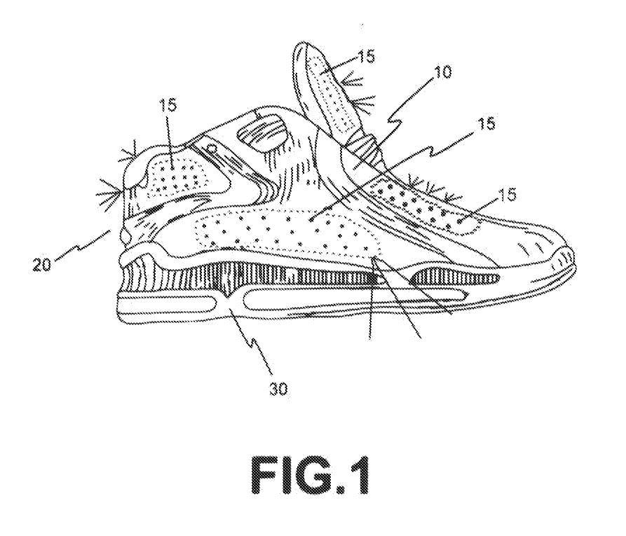

Referring to FIG. 1, there is disclosed a shoe having the entire upper surface of the upper portion of the shoe above the mid sole illuminated in one continuous uniform glow at the push of or switch of an on/off button. In a preferred embodiment of the present invention, the illuminated shoe comprises a mid sole 30, an upper above the mid sole 10, the light emitting means 15 underneath the surface of upper that illuminated the entire surface of the upper, a switch control device 20 connected to the light emitting means, and a power module connected to the light emitting means.

In one embodiment of the present invention, the light emitting means use LED bulbs as light source. The LEDs are placed underneath a portion of the surface of the upper and that portion of the surface of the upper is made up of a frosted or slightly transparent material. In another embodiment of the present invention, the LED bulbs are arranged in a way so that the lenses of the LED bulbs shine and point perpendicular to the surface of the shoe. In another embodiment of the present invention, the LED bulbs are arranged in a way so that the lenses of the LED bulbs point parallel to the surface of the shoe so that a uniform glow can be achieved. In another embodiment of the present invention, the lenses of the LED bulbs point in all sorts of different directions and are scattered throughout the shoe to illuminate all regions or a majority portion of the upper.

In another embodiment of the present invention, the light emitting means use light strips as a light source. The light strips are placed underneath a frosted or slightly transparent material just as the LED bulbs were as described above. The light strips would run long enough to cover significant portions of the shoe to give the shoe the continuous uniform glow.

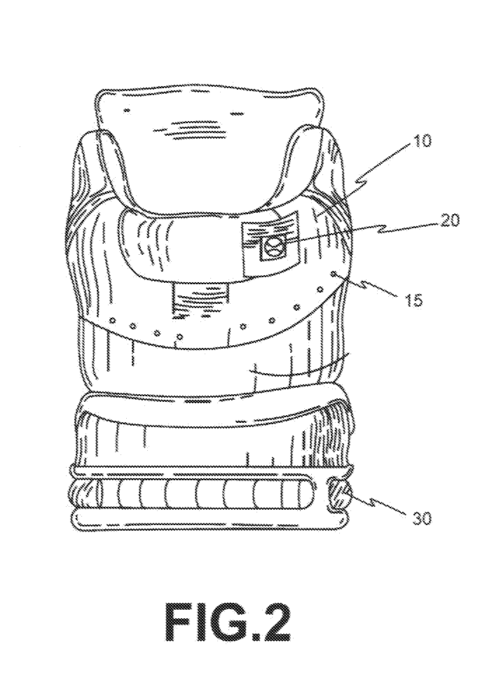

In another embodiment of the present invention, the switch control device 20 is a switch as shown in FIG. 1. In another embodiment of the present invention, the switch control device 20 is an on/off button as shown in FIG. 2. In another embodiment of the present invention, the on/off button is underneath the material of the shoe. Still in another embodiment of the present invention, the on/off button is exposed.

Still in another embodiment of the present invention, the power module is a battery. The battery compartment is built in the shoe and replaceable.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. An illuminated shoe comprising:
an upper;
a mid sole to which the upper is connected
a light emitting means placed underneath the surface of the upper;
a switch control device connected to the said light emitting means to activate the said light emitting means such that the light emitting means provide continuous illumination of the entire or a majority portion of the upper with a uniform glow regardless of whether the wearer is standing or walking; and
a power module connected to the said light emitting means to supply electricity to the light emitting means.

2. An illuminated shoe of claim 1, in which the light emitting means are LED bulbs placed underneath a portion of the surface of the upper where the said portion is made up of a frosted or slightly transparent material. The said LED bulbs are arranged in a way that the lens of the said LED bulbs point parallel to the surface of the upper so that a uniform glow can be achieved.

3. An illuminated shoe of claim 2, in which the said LED bulbs point in all sorts of different directions and are scattered throughout the shoe to illuminate all regions of the majority of the upper.

4. An illuminated shoe of claim 2, in which the LED bulbs are connected to a switch or an on/off push button which is exposed or placed underneath the surface of the upper. The said LED bulbs are also connected to a battery, where the battery compartment is built in the shoe and is replaceable.

5. An illuminated shoe of claim 3, in which the LED bulbs are connected to a switch or an on/off push button which is exposed or placed underneath the surface of the upper. The said LED bulbs are also connected to a battery, where the battery compartment is built in the shoe and is replaceable.

6. An illuminated shoe of claim 1, in which the light emitting means are light strips placed underneath a portion of the surface of the upper where the said portion is made up of a frosted or slightly transparent material. The said light strips run long enough to cover significant portions of the upper to give the surface of the upper the continuous uniform glow.

7. An illuminated shoe of claim 6, in which the said light strips are connected to a switch or an on/off push button which is exposed or placed underneath the surface of the upper. The said light strips are also connected to a battery, where the battery compartment is built in the shoe and is replaceable.

8. An illuminated shoe comprising
an upper;
light emitting means of LED bulbs placed underneath a portion of the surface of the upper where the said portion is made up of a frosted or slightly transparent material. The said LED bulbs are arranged in a way that the lens of the said LED bulbs point parallel to the surface of the upper and the LEDs point in all sorts of different directions and are scattered throughout the shoe to illuminate all regions of the majority of the upper in a continuous uniform glow;
a switch or an on/off button connected to the said LED bulbs. The on/off button is either exposed or placed underneath the upper material; and
a battery connected to the LED bulbs and the battery compartment is built in the shoe and is replaceable.

9. An illuminated shoe comprising
an upper;
light emitting means of light strips placed underneath a portion of the surface of the upper where the said portion is made up of a frosted or slightly transparent material. The said light strips run long enough to cover significant portions of the upper to give the surface of the upper the continuous uniform glow;
a switch or an on/off button connected to the said light strips. The on/off button is either exposed or placed underneath the upper material; and
a battery connected to the LED bulbs and the battery compartment is built in the shoe and is replaceable.
